(19) United States
(12) Patent Application Publication
(10) Pub. No.: US 2015/0311569 A1
(43) Pub. Date: Oct. 29, 2015

(54) Wearable Battery Charger

(71) Applicants: Aiping Yu, Waterloo (CA); Zhongwei Chen, Waterloo (CA); Gordon Chiu, Summit, NJ (US); Teresa Sung, Summit, NJ (US)

(72) Inventors: Aiping Yu, Waterloo (CA); Zhongwei Chen, Waterloo (CA); Gordon Chiu, Summit, NJ (US); Teresa Sung, Summit, NJ (US)

(21) Appl. No.: 14/689,362

(22) Filed: Apr. 17, 2015

Related U.S. Application Data
(60) Provisional application No. 61/980,651, filed on Apr. 17, 2014.

(51) Int. Cl. H01M 10/46; H01M 10/058; H01M 10/0565; H01M 10/0562; H01M 10/0525

(52) U.S. Cl. CPC H01M 10/46; H01M 10/0562; H01M 10/0525; H01M 10/0565; H01M 10/058; H01M 2300/0085; H01M 2300/0068; H01M 2300/0082

(57) ABSTRACT

An all graphene battery is disclosed. The battery is designed into a form of a belt and can charge multiple portable electric devices simultaneously. The battery has a graphene based anode, a graphene composite based cathode. The electrolyte of the battery is gel like functionalized graphene oxide. The device of this disclosure may use thermoelectric effect to charge itself. The battery of this disclosure is safe, and has a high capacity, high energy density and long life time. The battery includes no liquids and is light weighted.

### PRIORITY

This application claims priority to U.S. Provisional Application No. 61/980,651, filed on Apr. 17, 2014, the contents of which are hereby incorporated by reference.

### FIELD OF THE INVENTION

The present invention relates to wearable power systems (battery) made by all graphene components. The invention also relates to thermo electrics and to an emergency service.

### BACKGROUND OF THE INVENTION

During the last few decades portable electronic devices have become popular all over the world. Almost everyone is carrying one or more portable electronic devices with them. Such devices may be cellular phones, tablets, pacers, cameras, e-book readers and so on. The common feature in these devices is they are battery powered and need to be charged at time to time.

For a convenient charging a personal portable charger is preferable. Where the individual has more than one portable electronic device, it would be preferable to have a portable charger that can charge more than one device at a time.

There are some disclosures providing portable multi device chargers. U.S. Pat. No. 8,587,261 discloses a power system for continuously charging multiple battery powered devices.

U.S. Pat. No. 7,839,625 discloses a tool belt with smart cell technology. The belt contains a plurality of smart cells that can be power sources, audio/video or data collection cells. The power source cells could for example be batteries.

U.S. Pat. No. 8,169,185 discloses a portable device to charge plurality of devices such as smart phones etc. simultaneously. The device includes a base unit creating an alternating magnetic field and a unit receiving energy from the alternating magnetic fields. The device has an internal battery for self-powered operations and may be solar powered or may have a hand crank.

U.S. Pat. No. 8,587,261 discloses a portable power system for charging multiple battery powered devices, the power source is disclosed to be a zinc-air battery and hub/T-connectors provide electrical and mechanical connectivity between the power source and the chargers.

US2013/0191955 discloses a ballistic protective vest comprising fibers coated with an electrochemical capacitive layer. The vest is made of woven fibers coated with graphene and/or carbon nano-tubes placed in an electrolytic solution to store energy for powering electric devices.

Even if the above publications provide certain solutions to the problem of one or more portable electric devices needing to be charged, there are several issues that are still not solved:

There are no devices for charging one or more portable electric devices that would have light weight, and long life time, be powerful and safe. The devices described in the prior art use traditional Li-ion batteries. Such batteries include organic liquid electrolytes easy to decompose and produce water and then react with lithium and cause the battery to catch fire. Therefore, even if the above publications disclose devices that are wearable, such as the vest of US2013/0191955, there is a remarkable safety issue.

There is a need for a wearable device that would have a light weight. The prior art devices that have multiple conventional batteries are necessarily heavy and therefore not for everyday use.

There is also a need for a device for charging batteries that could use thermoelectric effect for self-charging.

Finally, there is a need for a device for charging batteries that could also have emergency call service included.

The invention disclosed solves the flaws of the prior art and provide other benefits the prior art devices do not provide.

### SUMMARY OF THE INVENTION

It is accordingly an object of this invention to provide a light weight, high capacity, safe, wearable battery for charging one or more devices simultaneously.

It is an object of this invention to provide an all graphene wearable battery.

It is another object of the invention to provide a wearable and safe battery that has superior anode capacity as compared to traditional graphite based batteries.

It is yet another object of the invention to provide a wearable and safe battery that has higher conductivity than any commercially available battery and therefore lower resistance and improved performance.

It is an object of this invention to provide a wearable battery having a high ion conductivity and improved safety.

It is still another object of this invention to provide a wearable all graphene battery that can use thermo electric effect for self-charging.

It is still another object to this invention to provide a safe wearable all graphene battery that includes an emergency alarm for emergency service.

It is another object of this invention to provide a graphene based battery comprising: a graphene based anode; a graphene composite based cathode; and a graphene oxide based electrolyte.

It is another object of this invention to provide a wearable graphene battery, comprising an electrolyte layer in between an anode layer and a cathode layer, wherein the anode layer comprises graphene and Si nanoparticles or graphene, Si- and Ti-nanoparticles; the cathode layer comprises graphene and nickel oxide, or graphene, nickel oxide and cobalt oxide or graphene and lithium nickel oxide or graphene and lithium cobalt oxide; and the electrolyte layer comprises functionalized graphene oxide, or functionalized graphene oxide and one or more polymer additives.

### BRIEF DESCRIPTION OF THE DRAWINGS

FIG. 1 is a schematic illustration of the structure of an all graphene battery according to this invention. The device comprises a graphene based anode; a graphene oxide based gel as electrolyte and a graphene based composite as the cathode. The three elements may be layered as shown in FIG. 1 to provide a wearable battery for example in the form of a belt.

FIGS. 2a and b show specific capacity of Graphene/Si Composite anode electrodes—half cell.

FIG. 3 shows full cell performance of Graphene/Si composite anode electrodes and graphene/lithium metal oxide cathode electrodes.

### DETAILED DESCRIPTION OF THE INVENTION

Graphene is one of the crystalline forms of carbon. In graphene carbon atoms are arranged in a regular hexagonal pattern. Graphene can be described as a one-atom thick layer of the layered mineral graphite.

Graphene has been synthesized by many methods including mechanical exfoliation (Scotch tape method), chemical vapor deposition, epitaxial growth, and solution based approaches. Fabrication of large-area graphene has been the challenge. An average size of graphene sheets made by the above mentioned methods is 0.5-1 μm².

International patent application publication WO2013/089642 for National University of Singapore which is incorporated herein by reference discloses a process for forming expanded hexagonal layered minerals and derivatives from graphite raw ore using electrochemical charging. Mesograf™ is large area few layered graphene sheet manufactured by the method disclosed in WO2013/089642. These few layered graphene sheets are made in a one step process from graphite ore have an area of 300-500 μm² on average. Mesograf™ is the preferable few layered graphene used in this invention and it is obtainable from Graphite Zero Pte. Ltd., Singapore. However, graphene made by other methods can be used as well for the device of this disclosure.

Mesograf™ has extraordinary characters that make it superior to other graphene materials. A Raman spectrum of Mesograf™ has almost no D-band as opposed to graphene made by Hummer's method. Raman spectroscopy is commonly used to characterize graphene. The band is typically very weak in graphite, but more pronounced in graphene made with Hummer's method.

Graphene is a highly conductive material. The few layered graphene (e.g. Mesograf™) has the same properties.

Graphene oxide is a compound of carbon, oxygen and hydrogen in variable rations. Traditionally graphene oxide is obtained by treating graphite with strong oxidizers and sonicating the resulting graphite oxide. Maximally oxidized graphene is yellow solid with carbon: oxygen ratio between 2.1 and 2.0.

Amphioxide™ is graphene oxidized at least 20% and obtained by directly oxidizing few layered graphene (Mesograf™). Amphioxide™ retains the layer structure of Mesograf™ Amphioxide™ is the preferred graphene oxide of this disclosure and it is obtainable from Althean Limited, Guernsey. However, graphene oxide obtained by oxidizing graphite may as well be used in the device of this disclosure. Graphene oxide sheets of this invention are preferably Amphioxide™ sheets and they have a lateral size of about 100 micrometers. The sheet may have lateral size as large as 200 micrometers.

Functionalization is a manner of adding new functions, features, capabilities or properties to graphene by changing the surface chemistry. Graphene oxide may be functionalized in various ways depending on the desired application. The functionalization can be performed by covalent and noncovalent modification techniques. In both cases, surface modification of graphene oxide followed by reduction is carried out to obtain functionalized graphene. In this invention the functionalized graphene is preferably sulfonated graphene oxide, but other functional groups may as well be used.

Preferred embodiments of the invention are now described.

According to a preferred embodiment of this invention a wearable battery is provided. The battery is flexible and preferably in the form of a belt, but it may be in other wearable forms as well.

According to a preferred embodiment the anode of the battery comprises graphene and silicon (Si)-nanoparticles.

According to another preferred embodiment the anode of the battery comprises graphene and silicon (Si)- and titanium (Ti)-nanoparticles.

According to one preferred embodiment the cathode of the battery comprises graphene and nickel oxide (NiO).

According to another preferred embodiment the cathode of the battery comprises nickel oxide (NiO) and cobalt oxide (Co₂O₃).

According to yet another preferred embodiment the cathode of the battery comprises graphene, and lithium nickel oxide (LiNiO) or lithium cobalt oxide (LiCoO₂).

According to one preferred embodiment the electrolyte of the battery is functionalized graphene oxide.

According to another preferred embodiment the electrolyte of the battery is functionalized graphene oxide and a polymer additive.

According to one preferred embodiment the functionalized graphene oxide is sulfonated graphene oxide.

The invention is now described in light of non-limiting examples. A skilled artisan understands that various changes and variations may be made to the examples without diverting from the spirit of this invention.

### EXAMPLE 1

### General Structure of the Wearable Battery

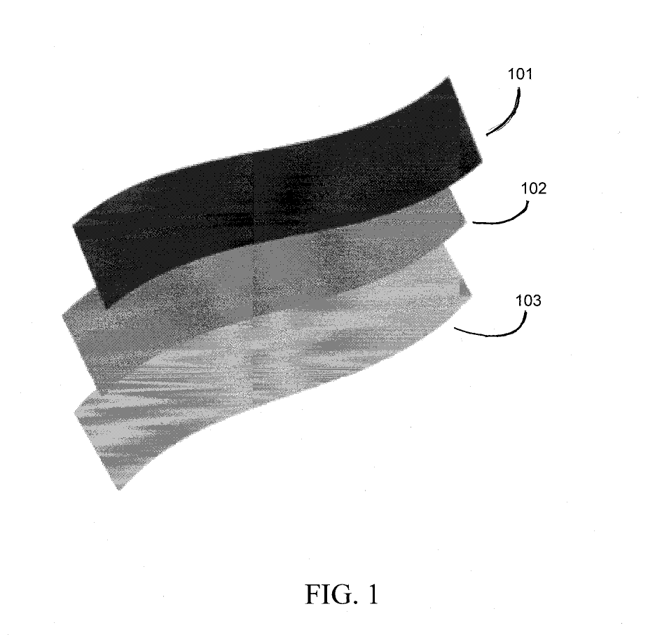

FIG. 1 shows the general composition of the wearable battery. The battery is composed of a graphene based anode and a graphene based composite cathode. The electrolyte of the battery is graphene oxide based gel that preferably is a layer located in between the anode layer and the cathode layer.

The wearable battery of this invention preferably has an outer layer that is anode and an inner layer that is cathode. The graphene based gel forming the electrolyte is in between the layers. According to an alternative embodiment the outer layer is cathode and the inner layer is anode.

The specific characteristic of the battery of this invention is flexibility. Therefore the battery can be made in form of a belt or any other wearable item.

The wearable battery of this invention is most preferably in the form of a belt used around the waist. The length of the battery may vary depending on the waist circumference measure of the user. Preferably the length of the battery is between 50 cm and 100 cm, but it may be as long as 300 cm or as short as 30 cm as well.

The wearable battery may alternatively be used around a wrist or bicep, in which case the length of the battery may vary for example between 10 cm and 20 cm.

The width of the wearable battery may be anything between 0.75 cm to 25 cm or even wider if needed.

The thickness of the wearable battery is preferably between 0.2 cm and 2 cm, but any other thickness may also be used.

The wearable battery may also be in form of any other wearable item, such as but not limited to head band, scarf, or vest. The battery may also be an integral part of a larger piece of clothing, such as part of a shirt, trousers or a jacket.

### EXAMPLE 2

### Composition of the Anode

The anode of the wearable battery preferably has a graphene core with silicon nanoparticles. Alternatively the anode has a graphene core with both silicon (Si) and titanium (Ti) nanoparticles.

The anode of the wearable battery preferably has a graphene framework with silicon nanoparticles. Alternatively the anode has a graphene framework with tin (Sn) materials, or both silicon (Si) and tin (Sn) materials. The synthesis of anode active materials includes dispersing Si nanoparticles in aqueous solution containing graphene oxide, freeze-drying the dispersion to form hydrogel, and low-temperature reduction of graphene oxide to graphene at a temperature of 80 to 150° C. The fabrication of anode includes mixing the active materials with commercial binder and conductive agent in solvent, coating slurry on current collector, drying the electrodes at 100° C. under vacuum, and pressing the electrode.

The weight proportion of the graphene and Si (or Sn) can be various from 5:95 to 90:10. Therefore, the specific capacity of anode calculated based on total mass of the active materials on anode can be various from 3000 to 600 mA h g⁻¹. This specific capacity of anode is at least 5 times higher than the capacity of a commercial graphite anode of 372 mA h g⁻¹.

### EXAMPLE 3

### Compositions of the Cathode

The cathode of the wearable battery is preferably graphene core with nickel oxide (NiO). Alternatively the cathode can have a graphene core with nickel oxide (NiO) and cobalt oxide (Co₂O₃). The cathode may also be of graphene plus lithium nickel oxide (LiNiO) or with lithium cobalt oxide (LiCoO₂).

The cathode of the device has higher conductivity than commercial batteries. The battery therefore has a low resistance which improves the battery performance.

The cathode of the wearable battery is preferably graphene framework with lithium cobalt oxide (LiCoO₂). Alternatively the cathode can have a graphene framework with lithium manganese oxide, or lithium ion phosphate, or vanadium oxides. The cathode may also be of graphene and lithium nickel manganese cobalt oxide.

The synthesis of cathode active materials includes dispersing commercialized or lab-synthesized LiCoO₂ materials in aqueous solution containing graphene oxide, freeze-drying the dispersion to form hydrogel, and high-temperature reduction of graphene oxide to graphene at a temperature of 450 to 950° C. depending on different materials. The fabrication of cathode includes mixing the active materials with commercial binder and conductive agent in solvent, coating slurry on current collector, drying the electrodes at 100° C. under vacuum, and pressing the electrode.

The weight proportion of the graphene and LiCoO₂ can be various from 5:95 to 90:10.

The cathode of the device has higher conductivity than commercial batteries. The battery therefore has a low resistance, which improves the battery performance.

### EXAMPLE 4

### Composition of the Electrolyte

The electrolyte is preferably a gel made of functionalized graphene oxide. The electrolyte may also include other polymer additives.

The electrolyte is preferably a gel form with conventional liquid electrolyte in a flexible gel made of functionalized graphene oxide. Alternatively, the electrolyte can also be in polymer form with polymers in functionalized graphene oxide gel. The conventional liquid electrolyte can be any of the commercialized lithium salt electrolyte such as 1 M LiClO₄ in PC, or 1 M LiPF₆ in EC/DEC (v/v=1/1). The polymers can be any of the commercialized polymers used in lithium-ion batteries such as PVA, PEO, PMMA, PAN, polyphosphazenes, siloxanes.

The synthesis of gel electrolyte includes the preparation of free-standing functionalized graphene oxide membrane, soaking the film in liquid electrolyte at different times in glovebox. The synthesis of polymer electrolyte includes the dispersion of polymers and additives in solvent, mixing the dispersion with functionalized graphene oxide dispersion, preparation of freestanding membrane by vacuum filtration or by spreading the dispersion on substrate followed by drying.

Importantly the electrolyte of this invention improves the safety of the device significantly as compared to commercials Li-batteries. Also the ion conductivity of the wearable battery is significantly higher and any other available battery.

Table 1 below provides the precursors, shows the groups attached to the graphene oxide and describes the reactions and structure of the composite.

TABLE 1
Precursors and stricter of the electrolyte compositions. Letters a) to h) in the Reaction
and structure-column refer to the reactions and structure provided below.

| | Attached groups on | |
|---|---|---|
| Precursor | Graphene oxide | Reaction and structure |
| 3-mercapto-propyl-trimethoxysilane | Epoxy and —OH | a) Condensation and oxidation of —SH |
| 1,3-propanesulfone | —OH | b) Esterification |
| 2-chlorohanesulfnic acid | —OH and —COOH | c) Substitution reaction of —Cl |
| Sulfanilic acid | Epoxy | d) Reaction between —NH₂ and epoxy |
| Cysteamine | epoxy | e) Reaction between NH₂ and epoxy and |
| | | oxidation of —SH |
| Sulfanilic acid diazonium salt | Aromatic rings | f) Displacement of N₂-group |
| Cysteamine diazonium salt | Aromatic rings | g) Displacement of N₂-group and oxidation |
| Ammonium sulfate | unclear | h) Sulfonation |
| Fuming sulfuric acid | unclear | h) Sulfonation |

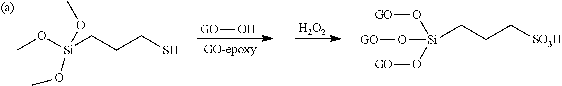

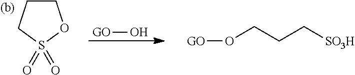

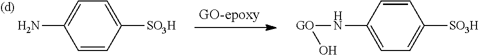

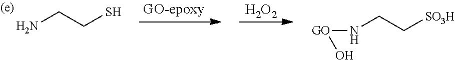

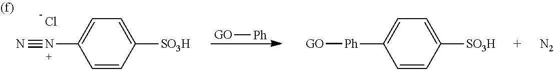

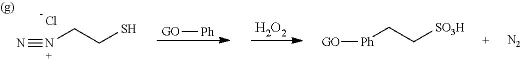

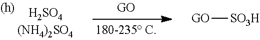

To make the electrolyte Li⁺ ion conductive Li⁺ is replaced by H⁺ by ion exchange at the last step of the above reactions.

### EXAMPLE 5

### Specific Capacity of a Half Cell Having Graphene/Si-Composite Anode Electrode

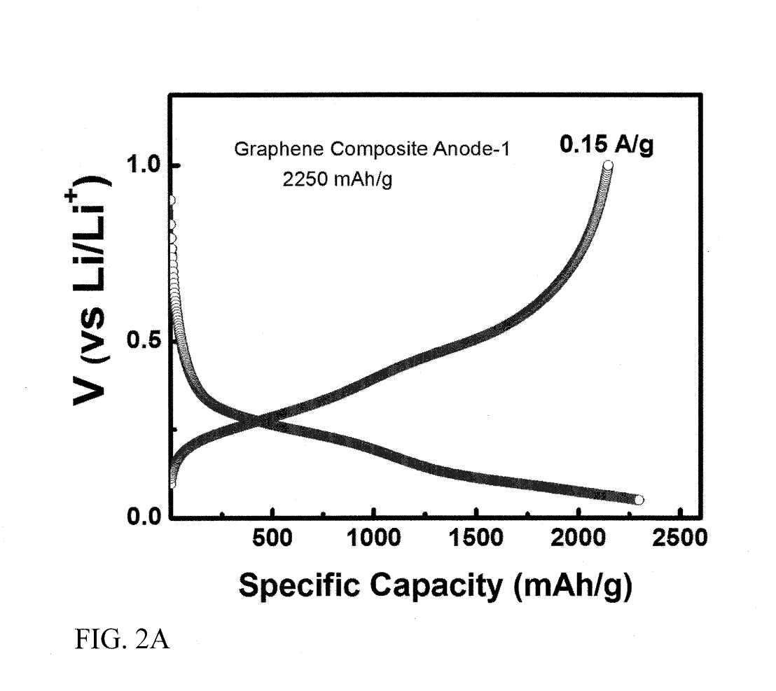

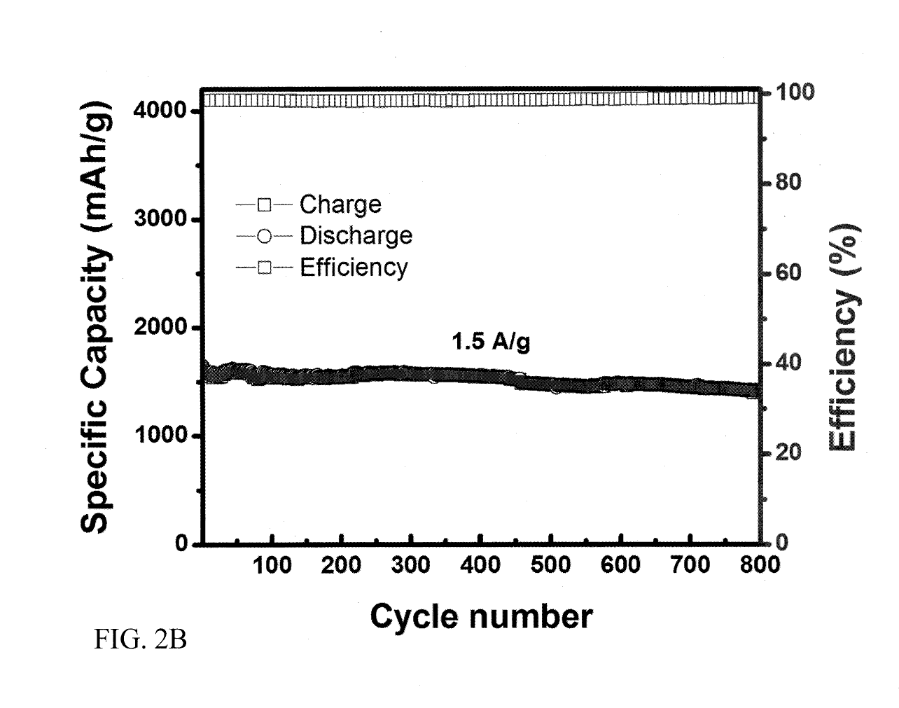

FIGS. 2 A and B show the specific capacity of a half cell having graphene/Si-composite anode electrode. FIG. 2A shows the initial discharge-charge curves of a half-cell having graphene/Si composite electrode. The initial specific discharge capacity of graphene/Si nanoparticles is 2275 mA h g⁻¹, while the initial specific charge capacity is 2210 mA h g⁻¹ of a half cell. FIG. 2B show the cycling performance of such a half-cell at a current density of 1.5 A g⁻¹. After 800 cycles, the electrode still exhibits a specific capacity of ˜1400 mA h g⁻¹, ˜95% of the capacity can be retained.

### EXAMPLE 6

### Performance of Graphene/Si Composite Anode Electrodes and Graphene/Lithium Metal Oxide Cathode Electrodes

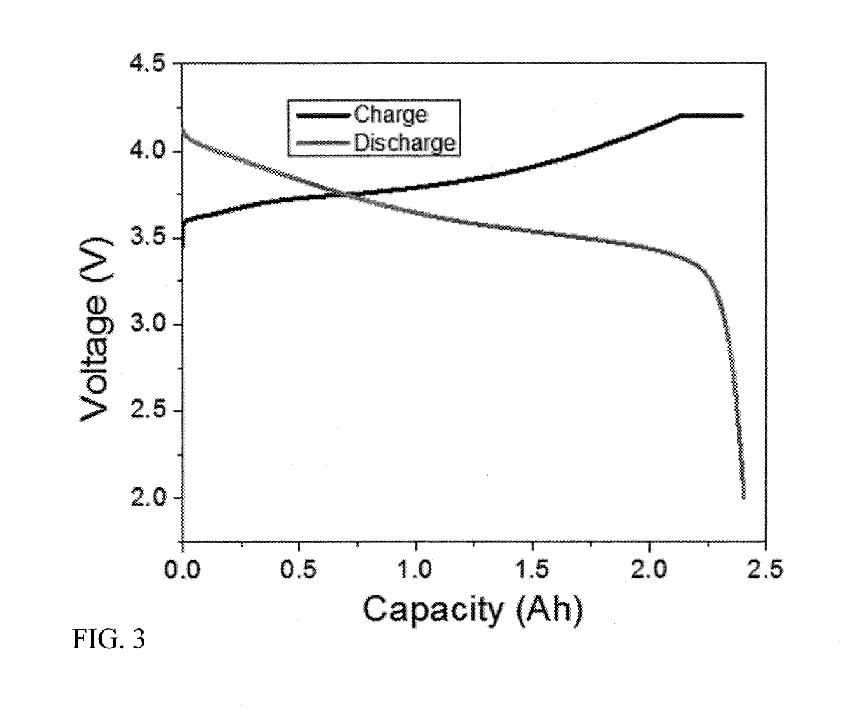

FIG. 3 shows the performance of a full-cell with graphene/Si composite anode electrodes and graphene/lithium metal oxide cathode electrodes. Such a full-cell exhibits a high working potential of ˜4.0 V with a discharge capacity of ˜2.4 A h.

### EXAMPLE 7

### Thermo Electric Charging of the Wearable Battery

Graphene exhibits high thermal conductivity, and high electron mobility. Graphene also exhibits interesting TE effects. The thermoelectric (TE) effect refers to phenomena by which either a temperature difference creates an electric potential or an electric potential creates a temperature difference. TE devices are generators and coolers to convert thermal energy into electrical energy or vice versa.

The device of the instant invention is an all graphene battery and it can use thermoelectric effect to convert thermal energy to electric energy. The device of this invention is preferably manufactured into a shape of a belt. A belt would be suitable for carrying and charging a multitude of portable devices such as cell phones. Besides the suitability for carrying, a belt would be a perfect shape for a thermoelectric device: the belt would have large enough area to be in contact with human body (skin or close to skin) and on the other hand it would have large enough area in contact with ambient air temperature. Being all graphene, the belt would be able to use the temperature difference of the body temperature and the ambient temperature and convert it to energy saved into the battery.

Therefore, the wearable battery would be ideal for anybody charging batteries, but especially the battery would be beneficial for someone in extreme conditions, such as hiking, skiing etc. in climates with high or low temperatures. Human body temperature is around 37° C. and the device could use the temperature difference of the extreme temperature of the air and the body temperature to charge the battery.

The wearable battery preferably has at least one indicator showing the charge level of the battery.

Although this invention has been described with a certain degree of particularity, the present disclosure has been made only by way of illustration and that numerous changes in the details of construction and arrangement of parts may be resorted to without departing from the spirit and the scope of the invention.

What is claimed is:

1. A graphene based battery comprising:
a graphene based anode;
a graphene composite based cathode; and
a graphene oxide based electrolyte.

2. The battery of claim 1, wherein the anode comprises graphene and silicon nanoparticles.

3. The battery of claim 2, wherein the anode additionally comprises titanium nanoparticles.

4. The battery of claim 1, wherein the anode has a capacity of about 5 times higher than graphite based anode.

5. The battery of claim 1, wherein the cathode comprises graphene and nickel oxide (NiO).

6. The battery of claim 5, wherein the cathode additionally comprises cobalt oxide (Co₂O₃).

7. The battery of claim 1, wherein the cathode comprises graphene and lithium nickel oxide (LiNiO) or lithium cobalt oxide (LiCoO₂).

8. The battery of claim 1, wherein the electrolyte comprises functionalized graphene oxide.

9. The battery of claim 8, wherein the functionalized graphene oxide is sulfone functionalized.

10. The battery of claim 9, wherein the electrolyte additionally comprises a polymer additive.

11. The battery of claim 10, wherein the polymer additive is selected from the group consisting of PVA, PEO, PMMA, PAN, polyphosphazenes, and siloxanes.

12. The battery of claim 1, wherein the battery is constructed of three layers, the outermost layers being the anode and the cathode and the layer in between the anode and cathode layer is the electrolyte layer.

13. The battery of claim 12, wherein the electrolyte is a gel.

14. The battery of claim 13, wherein the battery is in a form of a belt.

15. The battery of claim 14, wherein the battery is in contact with human body temperature and ambient air temperature and the battery can convert the temperature difference to electric energy via thermoelectric effect.

16. The battery of claim 14, wherein the battery has an emergency alarm button.

17. The battery of claim 14, wherein the battery can charge multiple portable electronic devices simultaneously.

18. A wearable graphene battery, comprising an electrolyte layer in between an anode layer and a cathode layer, wherein
the anode layer comprises graphene and Si nanoparticles or graphene, Si- and Ti-nanoparticles;
the cathode layer comprises graphene and nickel oxide, or graphene, nickel oxide and cobalt oxide or graphene and lithium nickel oxide or graphene and lithium cobalt oxide; and
the electrolyte layer comprises functionalized graphene oxide, or functionalized graphene oxide and one or more polymer additives.

19. The wearable graphene battery of claim 18, wherein the functionalized graphene oxide is sulfone functionalized.

20. The wearable graphene battery of claim 19, wherein the battery is in a form of a belt.

21. A method of making a battery said, method comprising the steps of:
a) providing anode active material by dispersing Si nanoparticles in aqueous solution containing graphene oxide, freeze drying the resulting dispersion to form hydrogel, and reducing graphene oxide to graphene at a temperature of 80° C. to 150° C.;
b) fabricating an anode by mixing the active material of step a) with a binder and a conductive agent in a solvent, coating slurry on current collector and drying the electrode at about 100° C. under vacuum;
c) providing cathode active material by dispersing LiCoO₂ material in aqueous solution containing graphene oxide, freeze drying the dispersion to form hydrogel, reducing graphene oxide to graphene at a temperature of 450° C. to 950° C.;
d) fabricating the cathode by mixing the active material of step d) with binder and a conductive agent in a solvent, coating slurry on current collector, and drying the electrode at about 100° C. under vacuum; and
e) providing a gel electrolyte by preparing a free standing functionalized graphene oxide membrane and soaking the film in liquid electrolyte.
